(19) United States
(12) Patent Application Publication
(10) Pub. No.: US 2019/0225515 A1
(43) Pub. Date: Jul. 25, 2019

(54) APPARATUS FOR SEPARATELY DISCHARGING GAS PARTICLES PRODUCED BY WATER ELECTROLYSIS

(71) Applicant: Hyun Duk Uhm, Seoul (KR)

(72) Inventor: Hyun Duk Uhm, Seoul (KR)

(21) Appl. No.: 16/369,871

(22) Filed: Mar. 29, 2019

Related U.S. Application Data
(63) Continuation of application No. PCT/KR2017/009646, filed on Sep. 4, 2017.

(30) Foreign Application Priority Data
Sep. 30, 2016 (KR) 10-2016-0126614

(51) Int. Cl. C02F 1/461; C25B 11/03; C25B 1/04

(52) U.S. Cl. CPC C02F 1/46109; C25B 11/03; C02F 2001/46166; C02F 2201/4611; C25B 1/04

(57) ABSTRACT

An apparatus for separately discharging gas particles produced by water electrolysis according to the present invention comprises: a container in which water and an electrolyte are contained; an electric generator disposed outside the container so as to generate power; and an electrode plate which is disposed within the container so as to electrolyze the water by being supplied with power from the electric generator, and includes a positive electrode plate having a high potential and a negative electrode plate having a low potential, wherein the positive electrode plate or the negative electrode plate is enveloped in a discharge tube made of an insulating material so as to discharge gas particles generated by the electrolysis to the outside atmosphere through the discharge tube.

### CROSS-REFERENCE TO RELATED PATENT APPLICATIONS

This patent application is a continuation of PCT/KR2017/009646, filed Sep. 4, 2017, which claims the benefit of Korean Patent Application No. 10-2016-0126614, filed Sep. 30, 2016, the entire teachings and disclosure of which are incorporated herein by reference thereto.

### TECHNICAL FIELD

The present invention relates to an apparatus for separately discharging gas particles produced by water electrolysis. More particularly, the present invention relates to an apparatus simultaneously or separately discharging oxygen and hydrogen produced during water electrolysis.

### BACKGROUND ART

Since hydrogen is a colorless, odorless, and tasteless element with strong reducing power, hydrogen is widely used for removing reactive oxygen species (ROS) in the body, which is known as a cause of modern diseases which are often called lifestyle diseases. Various types of products in relation with hydrogen have been released: a powder product in which hydrogen is occluded in minerals such as calcium in a high-temperature and high-pressure plasma state, a product that generates hydrogen by a chemical reaction between water and a metal such as magnesium, and a highly concentrated hydrogen drink fabricated such that a concentration of hydrogen dissolved is maximized. Recently, many hydrogen water-related products have been released at home and abroad.

Generally, hydrogen water is fabricated by using an apparatus for fabricating hydrogen water as illustrated in FIG. 1. The apparatus is configured such that a positive electrode and a negative electrode are immersed in water for electrolysis such that oxygen and hydrogen are produced by electrolysis. However, it is difficult to obtain pure hydrogen water by using the above-mentioned apparatus because oxygen is also dissolved in water with hydrogen

### DOCUMENTS OF RELATED ART

Korean Patent No. 10-1587697, published on Jan. 22, 2016

### BRIEF SUMMARY

Accordingly, the present invention has been made keeping in mind the above problems occurring in the related art, and the present invention is intended to provide an apparatus capable of dissolving hydrogen in water and discharging only oxygen to the atmosphere, or conversely, dissolving oxygen in water and discharging only hydrogen to the atmosphere.

In order to achieve the above object, there is provided an apparatus for separately discharging gas particles produced by water electrolysis, the apparatus including: a container in which water and an electrolyte are contained; an electric generator disposed outside the container to generate power; an electrode disposed within the container to electrolyze water using power supplied from the electric generator and including a positive electrode having a high potential and a negative electrode having a low potential; and a discharge tube made of an insulating material surrounding the positive electrode or the negative electrode such that gas particles produced by electrolysis are discharged to the atmosphere through the discharge tube.

The discharge tube may be in a form of a mesh having a predetermined size through which water passes and the gas particles produced by electrolysis do not pass.

An inner side of the discharge tube may be spaced apart from the electrode by a predetermined distance to define a passage through which the gas particles are moved upward.

The discharge tube may be configured such that one end thereof is located in water and an opposite end thereof is located outside of the water.

The discharge tube may be made of the insulating material so that there is no disturbance to an electric current.

An apparatus for separately discharging gas particles produced by water electrolysis according to the present invention prevents oxygen produced by electrolysis from being dissolved in water and discharges the oxygen to the atmosphere whereby only hydrogen, in a large amount, is dissolved in the water. Conversely, the apparatus prevents hydrogen produced by electrolysis from being dissolved in water and discharges the hydrogen to the atmosphere whereby only oxygen, in a large amount, is dissolved in the water.

### BRIEF DESCRIPTION OF DRAWINGS

FIG. 1 is a view illustrating a water electrolysis apparatus of the related art;

FIG. 2 is a front view illustrating an apparatus for separately discharging gas particles produced by water electrolysis according to an embodiment of the present invention;

FIG. 3 is an exemplary view illustrating the apparatus for separately discharging gas particles produced by water electrolysis according to the embodiment of the present invention is in use;

FIG. 4 is a rear view illustrating the apparatus for separately discharging gas particles produced by water electrolysis according to the embodiment of the present invention; and

FIG. 5 is an exemplary view illustrating an apparatus for separately discharging gas particles produced by water electrolysis according to another embodiment of the present invention is in use.

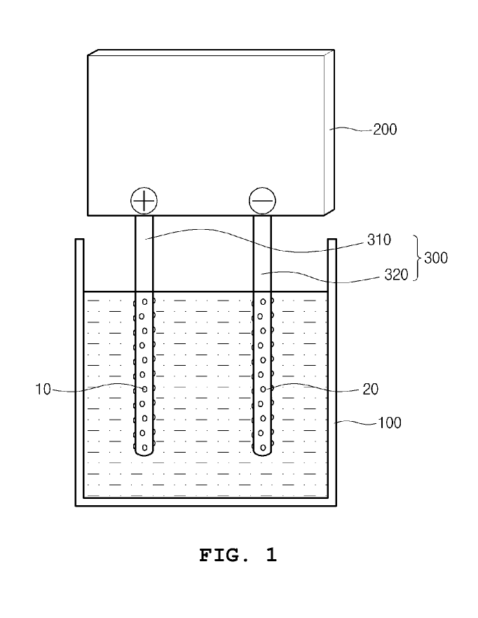

### DETAILED DESCRIPTION

Specific structural and functional descriptions of embodiments of the present invention disclosed herein are only for illustrative purposes of the embodiments of the present invention. The present invention may be embodied in many different forms without departing from the spirit and significant characteristics of the present invention. However, it should be understood that the embodiments according to the concept of the present invention are not limited to the embodiments, but various modifications, equivalents, additions and substitutions are possible, without departing from the scope and spirit of the invention.

Hereinafter, the present invention will be described in detail with reference to the accompanying drawings.

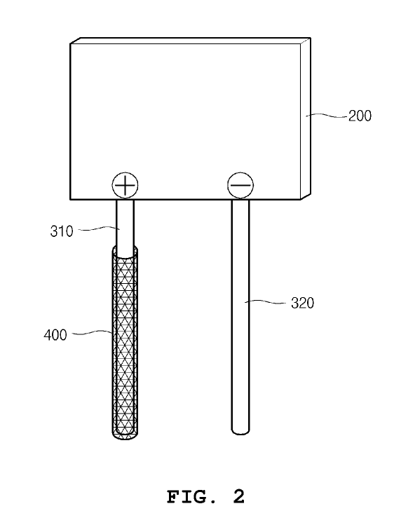

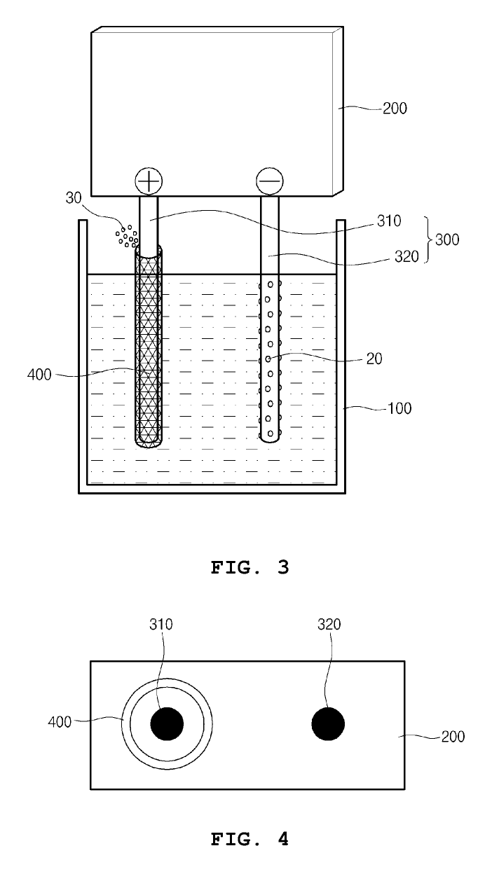

FIG. 2 is a front view illustrating an apparatus for separately discharging gas particles produced by water electrolysis according to an embodiment of the present invention; and FIG. 3 is an exemplary view illustrating the apparatus for separately discharging gas particles produced by water electrolysis according to the embodiment of the present invention is in use. The apparatus includes: a container 100 in which water and an electrolyte are contained; an electric generator 200 disposed outside the container 100 to generate power; an electrode 300 disposed within the container to electrolyze water using power supplied from the electric generator 200 and including a positive electrode 310 having a high potential and a negative electrode 320 having a low potential; and a discharge tube 400 made of an insulating material surrounding the positive electrode 310 or the negative electrode 320 such that gas particles produced by electrolysis are discharged to the atmosphere through the discharge tube 400.

Here, the gas particles include oxygen 10 and hydrogen 20.

The electrode 300 has a rod shape and includes the positive electrode 310 connected to a positive side of the electric generator and the negative electrode 320 connected to a negative side. The hydrogen 20 produced by electrolysis is collected on the negative electrode 320 and the oxygen 10 produced by electrolysis is collected on the positive electrode.

However, the electrode 300 is not limited to the rod shape but may be fabricated in various shapes for the sake of convenience of a user.

When the discharge tube 400 is provided to surround the positive electrode 310, the oxygen 10 is discharged to the atmosphere such that only the hydrogen 20 is dissolved in water.

The provision of the discharge tube 400 on the positive electrode 310 is intended to increase the amount of hydrogen 20 dissolved in water. Conversely, in order to increase the amount of oxygen 10 dissolved in water, the discharge tube 400 may be provided on the negative electrode 320.

The discharge tube 400 is made of an insulating material so that there is no disturbance to an electric current, and is in a form of a mesh having a predetermined size through which water passes and the oxygen 10 do not pass.

One end of the discharge tube 400 is located in water, and an opposite end is located outside of the water such that the oxygen 30 is discharged to the atmosphere

FIG. 4 is a rear view illustrating the apparatus for separately discharging gas particles produced by water electrolysis according to the embodiment of the present invention. An inner side of the discharge tube 400 is spaced apart from the electrode 300 by a predetermined distance, and the discharge tube 400 is provided to surround the electrode 300 such that a passage is defined thereby. The oxygen 10 produced by electrolysis is bulky and in a bubble form which is capable of being recognized by eye whereby it is impossible for the oxygen 10 to escape from the exhaust tube 400 having a mesh form and to be dissolved in water. Accordingly, the oxygen 10 is moved to the passage configured along an inner circumferential surface of the discharge tube 400 and discharged to the atmosphere through the end of the discharge tube 400, which is located outside of the water.

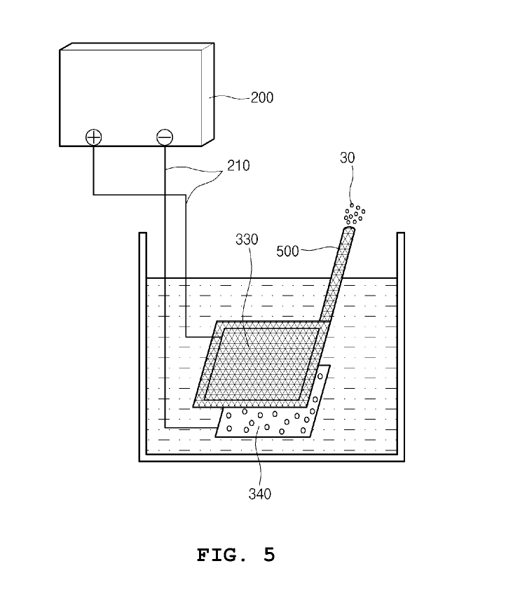

FIG. 5 is an exemplary view illustrating an apparatus for separately discharging gas particles produced by water electrolysis according to another embodiment of the present invention is in use, wherein an electrode 300 is provided such that a positive electrode 330 and a negative electrode 340 are configured in a quadrangular plate shape, and an electrical wire 210 connects between an electric generator and the electrode 300.

A discharge tube 500 is configured to cover the quadrangular positive electrode 330 being spaced apart by a predetermined distance and configured with a passage protruding to the outside of water to discharge the oxygen 10 to the atmosphere.

When power is supplied from the electric generator 200 through the electrical wire 210, the oxygen 10 is collected on the positive electrode 330 and the hydrogen 20 is collected on the negative electrode 340.

Here, the oxygen 10 having a large size collected on the positive electrode 330 can not escape to the outside of the discharge tube 500 having a mesh form. Thus, the oxygen 10 is moved through a space between the discharge tube 500 and the positive electrode 330 and discharged to the atmosphere through the protruding passage.

The hydrogen 20 collected on the negative electrode 340 is dissolved in water directly.

Although the embodiments of the present invention have been disclosed with reference to the accompanying drawings for illustrative purposes, those skilled in the art will appreciate that various modifications, additions and substitutions are possible, without departing from the scope and spirit of the invention as disclosed in the accompanying claims. It is thus well known to those skilled in that art that the present invention is not limited to the embodiment disclosed in the detailed description, and the patent right of the present invention should be defined by the scope and spirit of the invention as disclosed in the accompanying claims.

[Description of reference numerals in the drawings]

| | |
|---|---|
| 10: oxygen | 20: hydrogen |
| 30: oxygen in atmosphere | 100: container |
| 200: electric generator | 210: wire |
| 300: electrode | 310, 330: positive electrode |
| 320, 340: negative electrode | 400, 500: discharge tube |

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. An apparatus for discharging gas particles produced by water electrolysis, the apparatus comprising:
a container in which water and an electrolyte are contained;
an electric generator disposed outside the container to generate power;
an electrode disposed within the container to electrolyze water using power supplied from the electric generator and including a positive electrode having a high potential and a negative electrode having a low potential; and
a discharge tube made of an insulating material surrounding the positive electrode or the negative electrode such that gas particles produced by electrolysis are discharged to the atmosphere through the discharge tube.

2. The apparatus of claim 1, wherein the discharge tube is in a form of a mesh having a predetermined size through which water passes and the gas particles produced by electrolysis do not pass.

3. The apparatus of claim 2, wherein the discharge tube is provided to be spaced apart from the electrode to define a passage through which the gas particles produced by electrolysis are moved upward.

4. The apparatus of claim 2, wherein the discharge tube is configured such that one end thereof is located in water and an opposite end thereof is located outside of the water.

5. The apparatus of claim 2, wherein the discharge tube is made of the insulating material and in the form of the mesh so that there is no disturbance to an electric current.
